(19) United States
(12) Patent Application Publication
(10) Pub. No.: US 2021/0374270 A1
(43) Pub. Date: Dec. 2, 2021

(54) Digital Channel for Automated Parameter-Driven, Scenario-Based Risk-Measurement, Classification and Underwriting in Fragmented, Unstructured Data Environments And Corresponding Method Thereof

(71) Applicant: Swiss Reinsurance Company Ltd., Zurich (CH)

(72) Inventors: Clemens Ekkehard SCHMALE, Zurich (CH); Shazia KHAN, Zurich (CH)

(73) Assignee: Swiss Reinsurance Company Ltd., Zurich (CH)

(21) Appl. No.: 17/096,461

(22) Filed: Nov. 12, 2020

Related U.S. Application Data
(63) Continuation of application No. PCT/EP2020/065129, filed on Jun. 1, 2020.

(51) Int. Cl. G06F 21/62; G06F 16/215; G06F 21/57

(52) U.S. Cl. CPC G06F 21/6227; G06F 21/6209; G06F 21/57; G06F 16/215

(57) ABSTRACT

A digital device is provided for automated risk-transfer underwriting in fragmented, unstructured data environment. The digital device includes a plurality of sensors, a storage configured to store transfer portfolio data, and circuitry configured to measure characteristics parameters of a plurality of objects, assign the measured characteristics parameters to a profile associated with the plurality of objects, classify the plurality of objects into a plurality of classes based on the measured characteristics parameters, generate a transfer cover value based on (i) the measured characteristics parameters and (ii) a relationship between a risk source, a risk exposure measure, and a risk exposed object of the transfer portfolio data, assign the generated transfer cover value to the corresponding section of the profile for the risk exposed object, and generate a risk score value to the corresponding section of the profile based on the assigned transfer cover value.

### CROSS REFERENCE TO RELATED APPLICATION

This application is a Continuation of PCT application no. PCT/EP2020/065129 filed Jun. 1, 2020, the entire contents of which is incorporated herein by reference.

### FIELD OF THE INVENTION

The present invention relates to an automated digital channel for automated parameter-driven, scenario-based risk-measurement, classification and risk-transfer underwriting in fragmented, unstructured data environments covering heterogenous risk sources and risk-exposure classes associated with assets of small and/or medium size enterprises (SME), wherein the digital channel is provided by an automated digital platform for the risk-exposed units assessing the digital platform by means of network-enabled devices via a data transmission network. Further, the present invention relates to intelligent, automated and optimized technologies for inter-active steering, monitoring and adapting/optimizing of risk-transfer products. More particularly, it relates to systems for automation of underwriting, risk management, risk-transfer and risk portfolio steering and signaling involving an improved composing and configuring of products for a user interactively.

### BACKGROUND OF THE INVENTION

Automation and interactive steering of risk-transfer processes are complex and technically extremely challenging, especially, if the risk-exposers are associated with a pool of different assets and risks. The reason behind are various, such as the prediction and probability measurements of quantifiable risk and risk-exposure, respectively, based on measured physical parameters i.e. related the actual or future occurrence physical events as natural catastrophes, earthquakes, hurricanes, floods or viral epidemies. Another reason is, for example, the difficult to measure impact link between the physical asset and strength of the physical risk event. Thus, the technical challenges for automated determination, monitoring and steering of appropriate risk-transfer parameters are manifold, where the risk-transfer parameters are defining the portion of the risk which is transferred typically balanced and in exchange of monetary parameter values as part of an underwriting process. Also the generation of quotes for coverage, which relies on the above-mentioned parameters, is technically complex, which is another factors used in quoting and other risk-transfer processes provided to risk-exposed entities is the risk classification of the entity. The risk classification of a risk-exposed entity can be an important factor in determining risk-transfer risk.

As mentioned, risk-transfer processes and underwriting involves the evaluation, measurement and prediction of risks of risk-exposed units or entities. Underwriting often includes determining a monetary transfer amount (premium) that needs to be charged to tune and balance the amount of risk transferred with the monetary amount. Traditionally, insurance companies typically have their own set of underwriting guidelines to help determine whether or not the company should accept the risk. The information used to evaluate the risk of an applicant for insurance can depend on the type of coverage involved. However, insurance profitability is often based on 30-year-old and older underwriting settings and processes. Moreover, the risk-transfer industry is highly fragmented and utilizes restricted and retrospective data sets, with little connectivity among underwriters, distributors and the risk-exposed units, they serve. Thus, risk-transfer system seek growth but are technically challenged and limited by high cost ratio's, mismatch of existing risk-transfer products and fragmented, unstructured data.

Known in the prior art are automated or semi-automated risk-transfer systems, typically interacting with a user via graphical user interface (GUI). In particular, automated, cloud-based systems enabling an end-user to compose automatically a first-tier (insurance) and/or second-tier (reinsurance) risk-transfer products, after conducting a dialogue with a knowledge-based system, are known. Such systems reduce the dependences of first-insurers or reinsurers on both their information technology (IT) and their human experts, as e.g. actuarial experts. Such systems are able to adjust the dialogue interactively according to the specific needs of the users and ask for the relevant data needed for the desired risk-transfer product.

Today, automation of the underwriting process is not enough to cope with the challenges mentioned above. The increasingly dynamic and diversified risk-transfer market requires shorter time-to-market of highly customized (re)insurance products. Such process are technically difficult to automatize. Thus, though the prior art system are able to automate or semi-automate the underwriting process, there is still a need for a complete electronically automated solution covering the whole facultative risk-transfer process. In particular, there is no system (i) providing a fast, consistent and easy access to portfolio risk-transfers, thereby allowing to reduce administration costs for managing SME risk portfolios, (ii) to access fast, automatic capacity approval for SME risks or facilities, and (iii) to relieve administration time, to focus on more complex parts of the risk-transfer. In summary, there is a need for an easy-to-use and efficient online risk placement, claims and accounting channel for SME clients covering the whole process of the risk-transfer, i.e. the entire value chain providing an end-to-end process, thereby providing fast composing, launch and configuration of highly customized risk-transfer products.

In summary, processor-driven systems with user interfaces for automated receiving data for binding contract conclusions between a user and a digital platform or channel are known in the prior art, in particular, via the Internet. In the field of risk-transfer technology, such systems or platforms are e.g. automated underwriting (UW) platforms. To increase the quality of the data acquisition, the known systems are typically equipped with validation means in order to check the input data values on the basis of data rules which are assigned to data input fields of the user interfaces and for requesting, if necessary, corrections via the user interface. In the case of products or services which are assigned to fixed purchase prices, sales contracts can be automatically concluded on-line by the known systems. If, however, the objects of contracts relate to service structures/products which cannot be simply assigned to contract conditions and, in particular, prices on an individual one-to-one basis, the known systems are only suitable for data acquisition for ordering services or applying for services which must be dealt with manually by professional assistants of the service provider at a later time. This means that contracts for services which are dependent on many conditions and factors, for example risk-transfers which depend on numerous and different risk factors and risk-transfer conditions, cannot be concluded automatically and on-line by the known systems, nor can such risk-transfers or portfolios or baskets of risk-transfers be dynamically adapted form user side without human assistance from the provider side.

### SUMMARY OF THE INVENTION

It is an object of the invention to allow for systematic capturing, measuring, quantifying, and forward-looking generating of appropriate risk and risk accumulation measures of risk-transfers and risk-transfer portfolios associated with risk exposures of physical real-world assets based on physical measuring parameter values and data, i.e. the impact of a possibly occurring physical event in a defined future time window. It is a further object of the present invention to propose a processor-driven system or platform providing an automated digital channel for automatically concluding and dynamically adapting risk-transfers between a risk-transfer service user and a risk-transfer service provider, which does not exhibit the disadvantages of the known systems. In particular, the invention should provide a digital channel dedicated to SME and more particular to micro and small enterprises' risk-exposures. Micro and small enterprises represent 90% of total global businesses and employs more than 50% of the global workforce, and thus micro and small enterprises are a vital part of the global economy. The invention should allow to overcome the disadvantages of the prior art systems which resulted in a assumed protection gap of 85%. The invention should be enabled to provide an automated risk advice for SME risks with high data quality and trusted advice. The invention should allow to combine internal and external data sources of risk-transfer systems. Further, it should help SMEs better understand their business risks, and allow for automated monitoring and applying of recommend mitigation actions in addition to risk-transfer covers. The invention should enable automated underwriting (UW) and pricing of risk-transfer covers with increased efficiency by (i) automatically providing base rates to support pricing of SME risk-transfers, (ii) using traditional and novel data sources, and (iii) simplifying the quotation process by reducing the overall number of questions and applying behavioral science. By providing automated consulting services specific to the SME segment, the invention should be able to help risk-transfer systems to increase their SME business, increase their profitability and enhance their efficiency, and further provide actionable, tangible and data-driven business insights.

Finally, it is an object of the present invention to propose a processor-driven, digital platform which comprises a user interface, which can be operated by means of terminals via a data-transmission network for users, comprising data input fields for inputting data relating to the object of a risk-transfer, which is available and can be used as a one-stop, end-to-end process for conducting, monitoring and adapting risk-transfers or portfolios of risk-transfers by the user independently of the location or the desired object of a contract (service). In particular, it is a further object of the present invention to propose a processor-driven, computer-based networking platform which comprises a universal user interface which can be adapted flexibly to variable risk-transfer conditions and risk-transfer types of an automated binding process without changes which are visible to the service user. The used inventive technical teaching should be easily integratable in other processes or risk assessment systems. Finally, the invention should be enabled to use data and measuring parameter values from multiple heterogeneous data sources. The probability and risk forecast should allow to capture various device and environmental structures, providing a precise and reproducible measuring of risk factors, and allowing to optimize associated event occurrence impacts of the risk events.

According to the present invention, these objects are achieved, particularly, with the features of the independent claims. In addition, further advantageous embodiments can be derived from the dependent claims and the related descriptions.

According to the present invention, the above-mentioned objects for a digital channel for automated risk-transfer and automated risk-transfer underwriting in fragmented, unstructured data environments covering heterogenous risk sources and risk-exposure classes associated with assets of small and/or medium size enterprises, are achieved, particularly, in that, by means of the present invention, the digital channel is provided by a digital platform for the risk-exposed units assessing the digital platform by means of network-enabled devices via a data transmission network, wherein risk-transfer portfolio data are held in a persistence storage of the digital platform and comprise at least one assigned relationship between a risk source, risk exposure measure and a risk exposed asset of a risk-exposed unit, in that the digital platform comprises a risk advisory module for automated asset segmentation, classification, risk scoring and interactive exposure steering, wherein asset characteristics parameters of a unit are captured and assigned to a risk profile of the unit, and wherein the assets of the unit are segmented and classified into predefined asset classes based on the captured asset characteristics parameters, in that the risk profile comprises a plurality of profile section comprising asset section being associated with an asset class and risk sections being associated with a risk type, wherein each predefined asset class is linked with one or more risk types and each predefined risk type is linked with one or more asset classes, in that the digital platform comprises an automated underwriting and pricing module, wherein base rates for applicable risk-transfer covers are provided and corresponding pricings are generated based on the base rates, associated rate factors and value parameters of the asset characteristics parameters, wherein different applicable risk-transfer covers are generated based on the correspondingly relationship between a risk source, a risk exposure measure and a risk exposed asset and are assigned to a profile section of the risk-exposed unit, and in that a risk score is generated by the risk advisory module and assigned to each profile section of the risk profile, wherein the interactive portfolio steering is provided by inter-actively assigning and adjusting risk-transfer covers to the risk-transfer portfolio by a unit associated with said portfolio.

### BRIEF DESCRIPTION OF THE DRAWINGS

The present invention will be explained in more detail, by way of example, with reference to the drawings in which:

FIG. 1 shows a block diagram schematically illustrating an exemplary digital platform 1 comprising the digital system 1′ and providing the digital channel for automated risk-transfer in fragmented, unstructured data environments covering heterogenous risk sources 1142 and risk-exposure classes 1141 associated with assets 2i1 of small and/or medium size enterprises 21,22, . . . , 2i (SME). The digital channel is provided by an automated digital platform 1 for the risk-exposed units 2, 21,22, . . . ,2i assessing the digital platform 1 by means of network-enabled devices 2i2 via a data transmission network 4. Risk-transfer portfolio data 101, 102, . . . , 10i are held in a persistence storage 10 of the digital platform 1 and comprise at least one assigned relationship 10i 1 between a risk source 10i 11, risk exposure measure 10i12 and a risk exposed asset 10i13 of a risk-exposed unit 21,22, . . . ,2i. The digital platform 1 comprises a risk advisory module 11 for automated asset segmentation 1261, classification 1262, risk scoring 1263 and interactive exposure steering 1264. Asset characteristics parameters 1121 of a unit 21,22, . . . ,21 are captured and assigned to a risk profile 112 of the unit 21,22, . . . ,2i.

FIG. 2 shows a block diagram schematically illustrating the relation between the SME Index, the risk events, the risk scoring and the risk scenarios, wherein the SME Index measure providing at least location parameter values, attributes' values of the assets 2i1 and/or the risk-exposed units 2, 21,22, . . . ,2i and activities' parameter values of the assets 211 and/or the risk-exposed units 2, 21,22, . . . ,2i. The risk events are a defined set of inherent and exogenous risks, i.e. probabilities for the occurrence of a risk event within a defined range of physical measuring parameters and a future measuring time period. The SME Index measure determines which risk events or hazards are relevant and how they are influenced, i.e. how frequent and severe they are. The scoring is the technical structure assigning relevant risks to the assets 2i1. Each measured attribute value increases/decreases the risk measure to different extent. For example, the measured flood risk for asset equipment 2i1 combined with risk measures for all other assets 2 providing total score for the measured flood risk measure. The triggered list of risks for the risk-exposed unit 2, 21,22 2i ranks from greatest to smallest measured risks for this particular risk-exposed unit 2, 21,22 2i. The implemented scenarios provides a risk structuring. The selected scenario for each risk show the most relevant risk driver for that particular risk-exposed unit 2, 21,22, . . . ,2i. Further, scenarios reflect location, attributes, activities and hazards and are customized to it, e.g. measured cyber risk=high (high because: website host, online registration, security measures). The greatest vulnerability measure (booking system) is equal to the scenario basis.

FIGS. 3 and 4 show block diagrams schematically illustrating embodiment variants of the implemented data modelling structure.

FIG. 5 shows a block diagram schematically illustrating the automated parameter-indexing module 110 which is one of the backbones of the inventive platform 1, providing the underlying SME and risk data to score the risks and populate the risk scenario of the units 2/21,22, . . . ,2i and SMEs, respectively. As embodiment variants, additional extensions are possible, as for example 1. Business Activity Identifier, 2. Crime API, 3. Website Validation, connected to the parameter-indexing module 110 to improve its data completeness and accuracy.

FIG. 6 shows a block diagram schematically illustrating a non-exhaustive list of relevant data attributes of the index-data structure 1101.

FIG. 7 shows a block diagram schematically illustrating an architecture of SME Identification process used by the parameter-indexing module 110. In this embodiment variant, the inventive platform runs on AKS (Azure Kubernetes Service) and use Azure File Storage & Azure Disks for data persistence.

FIG. 8 shows a block diagram schematically illustrating an exemplary processing and rule structure comprising the steps of (1) Insured information is provided (such as name, country, city, turnover, industry . . . ); (2) Unit/Company name is standardized (e.g. in Switzerland SARL becomes GmbH); (3) Similar companies based in the provided information are selected from the ElasticSearch instance; (4) Each matching company is scored using machine learning to compute how much it fits with the requested information; (5) Best company is selected based on score; (6) Company information is enriched (industry labels are extracted from the industry code, revenue and employees are bucketed . . . ); and (7) Information is sent back

FIG. 9 shows a block diagram schematically illustrating an exemplary identification of unit/business activities in three parts: (1) Mapping the Website: The website is scouted to identify all sub-links present on the website in order to map out the entire website framework; (2) Scraping the Data: Gather the text from all of the sub links of the websites to have coverage of all of the text information on the website; and (3) Searching for Keywords: Search the gathered text information for key words which indicate certain activities being undertaken by the business.

FIG. 10 shows a block diagram schematically illustrating an exemplary basic scoring process. It provides scores for all assets and all risks. The resulting numerical value is translated into intuitive visual information.

FIG. 11 shows a block diagram schematically illustrating an exemplary process determining and displaying the relevant scenario depending on the score. Scenarios are a centerpiece of the risk advisory module 11. The risk scoring provides insights into riskiness. The advisory interprets the results for the end-user for each asset and risk. It provides answers to the questions of (i) What is it?, (ii) What can happen?, (iii) What can you do about it?. For each possible combination of location, activities and attributes there are scenarios available.

FIG. 12 shows a diagram schematically illustrating a view of the assets of a SME, i.e. a risk-exposed unit 21,22, . . . ,2i. The risk-exposed units 21,22, . . . ,2i view their operations in terms of their assets 2i1. The inventive platform 1 segments and classifies assets into classes and offers a holistic view of the associated risk 1125 of each class 1131 in the risk profile section 1123.

FIG. 13 shows a diagram schematically illustrating an exemplary view of a SME risk profile, i.e. a risk-exposed unit's 21,22, . . . ,2i risk profile. The risk view displays the perils at the source of the risk 1125. The grey bar shows risks 1125 with sufficient data to provide a risk score 1124. A simple set of questions can be answered via the interface 16 for perils where data is not available to provide a risk score.

FIG. 14 shows a diagram schematically illustrating exemplary high-quality data tailored by the invention to each type of risk. Detailed exposure data in the form of high quality maps and history associated with the type of risk are provided. The further allows providing additional prevention measures tailored to each type of risk to reduce their risk exposure.

FIG. 15 shows another diagram schematically illustrating the exemplary streamlined UW process and generation of a simple link between risks and risk-transfer covers. The invention allows providing a view and monitoring of all the relevant risk-transfer covers specific to the SME 21,22 2i.

### DETAILED DESCRIPTION OF THE PREFERRED EMBODIMENTS

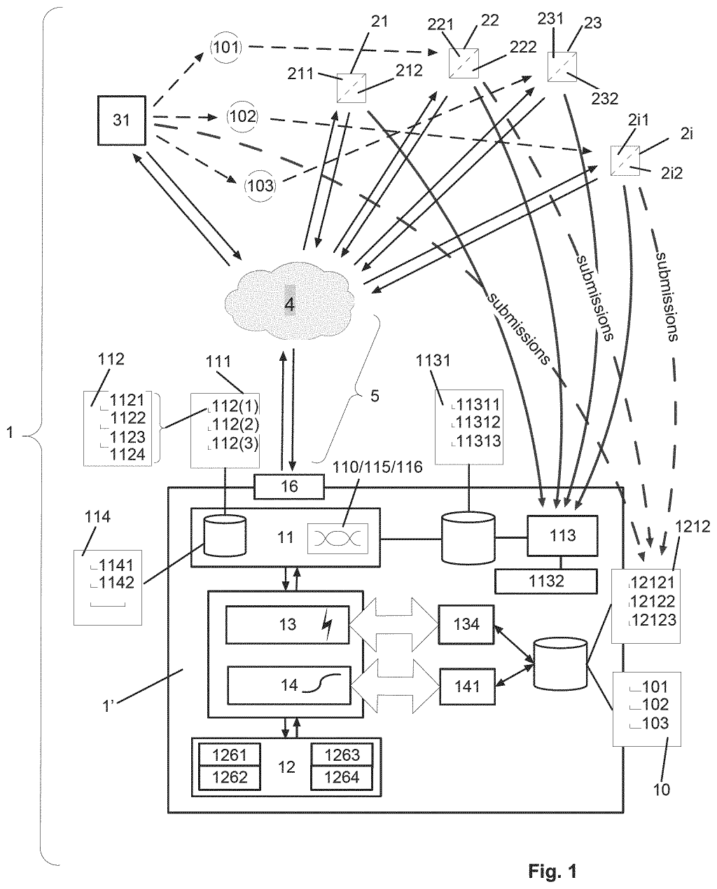

FIG. 1 schematically illustrates an architecture for a possible implementation of an embodiment of the end-to-end digital channel for automated risk-transfer in fragmented, unstructured data environments covering heterogenous risk sources 1142 and risk-exposure classes 1141 associated with assets 211 of small and/or medium size enterprises 21,22, . . . ,2i (SME). The digital channel is provided by a digital platform 1 for the risk-exposed units 2, 21,22, . . . ,2i assessing the digital platform 1 by means of network-enabled devices 2i2 via a data transmission network 4. Risk-transfer portfolio data 101, 102, . . . ,101 are held in a persistence storage 10 of the digital platform 1 and comprise at least one assigned relationship 10i11 between a risk source 10i11, risk exposure measure 10i12 and a risk exposed asset 10i13 of a risk-exposed unit 21,22, . . . ,2i.

The digital platform 1 comprises a risk advisory module 11 for automated asset segmentation 1261, classification 1262, risk scoring 1263 and interactive exposure steering 1264. Risk as understood herein is a physical quantity, providing a physically reproducible measure for the probability of the occurrence of a defined physical event, so called risk event, as e.g. a hurricane, flood, car accident, illness, earthquake etc. These risk events are physical events which are detectable by means of appropriate measuring devices by measuring physical measuring parameters. Such risk events have a physically measurable impact on a physical object, herein referred as risk-exposed units 2/21,22,23, . . . ,2i. Thus, risk exposure, as used herein, is a physical measure for the physical probability of the actual future occurrence of a risk-event having a defined measurable impact on a risk-exposed units 2/21,22,23, . . . ,2i. For the machine-based prediction and forecast of such probability measures for future time periods, similar to the forecast of weather forecast measuring systems, the technical field uses machine-based predictive techniques, which typically are based on physically measured measuring parameters having physical measuring quantities as output, i.e. temperature or wind speed for a defined future point in time or time period based on temperature and/or wind speed etc. measured in the present and/or in past times periods. The term “predictive techniques” as used herein, includes any machine steering rules or technique using machine-based intelligence, as artificial intelligence or machine-learning structures, and/or statistical techniques for using a data-processing device (in combination with measuring devices or sensors capturing the appropriate input parameter values) to determining a probable one of a set of possible output measures or values, based on input measuring data. Predictive techniques are typically created by applying suitable machine-steering structures to sets of data having known results, identified as training data, and then testing resulting predictive techniques against a set of similar data. Predictive techniques may be understood as heuristic techniques for determining classifications based on input data. Examples of predictive techniques include the rotation forest and random forest technique, other classification trees, and other classification model types, such as naïve Bayesian models, Bayesian network models, K-Nearest neighbor models, support vector machines, machine-based learning and artificial intelligence, as inter alia neural network based machine learning.

Asset characteristics parameters 1121 of a unit 21,22, . . . ,2i are captured and/or measured, and transferred to the digital system 1′ over the network interface 16 via the data-transmission network 4. The transferred asset characteristics parameters 1121 are assigned to a risk profile 112 of the unit 21,22, . . . ,2i. The asset characteristics parameters 1121 of a unit 21,22, . . . ,2i can be measured by appropriate measuring devices or sensors 2i11, . . . ,2i1x associated with a unit 21,22, . . . ,2i and/or its assets 2i1. The measuring devices 2i11, . . . ,2i1x can comprise wired sensors connected to a data interface or PLC (Programmable Logic Controller) controlling a plant or electronic steered devices, both being accessible over the data transmission network 4 or telematic measuring devices 2i11 2i1x, in particular mobile telematics devices, as e.g. measuring devices 211, . . . ,2i1x of smart homes or autonomous or semi-autonomous driving vehicles being accessible over a cell-based mobile network 4. Thus, the measuring devices or sensors 2i11, . . . ,2i1x associated with a unit 21,22 2i and/or its assets 2i1 can directly be accessible and steered by the digital system 1′ of the digital platform 1 by means of the data interface 16 of the digital system 1′ and the network interfaces 2i21 of the measuring devices or sensors 2i11, . . . ,2i1x or a PLC. To measure the asset characteristics parameters 1121, the measuring devices or sensors 2i11, . . . ,2i1x can comprise all kind of operation or field devices, as for example device controllers, valves, positioners, switches, transmitters (e.g., temperature, pressure and flow rate sensors) or other appropriate technically devices.

The assets 2i1 of the unit 21,22, . . . ,2i are segmented and classified into predefined asset classes 11211, . . . ,1121i based on the captured asset characteristics parameters 1121. As described above, the digital platform 1 can detect various asset characteristics parameters 1121 of a unit 21,22, . . . ,2i and, furthermore, recognize them and infer complex electronic signaling and steering tasks from associated measuring devices. In particular, system 1 is capable of classifying assets 2i1 of the unit 21,22, . . . ,2i based on the detection, measuring and/or otherwise capturing of asset characteristics parameters 1121 and measure their intensity or other measures associated with a certain asset 2i1. The present invention provides, inter alia, a new technical arrangement for the automated recognition and classification of asset 2i1 improving its functionality using technical approaches, such as simple thresholding or dynamic time warping (DTW) or heuristic methods. In embodied variants, the digital platform 1 is also implemented using a suitable unsupervised or supervised machine learning classifier, such as, e.g., maximum likelihood (ML) classifier techniques, to identify and classify driving maneuvers or suitable neural network approaches, such as convolutional NN, recurrent NN or even standard back propagation NN. In further variants, the digital platform 1 has also successfully been implemented using other functional data processing (FDA) techniques, in particular symbolic aggregate approximation (SAX) techniques or piecewise aggregate approximation (PAA) techniques. The implementation of the different technical approaches depends, at a minimum, on the captured data. However, in connection with the present inventive data cleaning process, in identifying asset 2i1 and classifying thereof, dynamic time warping (DTW) may be a choice.

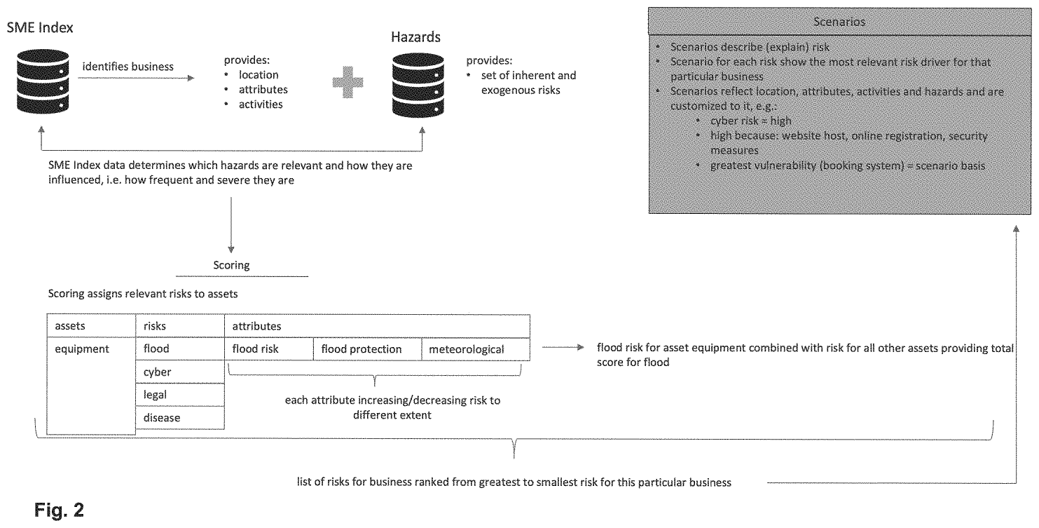

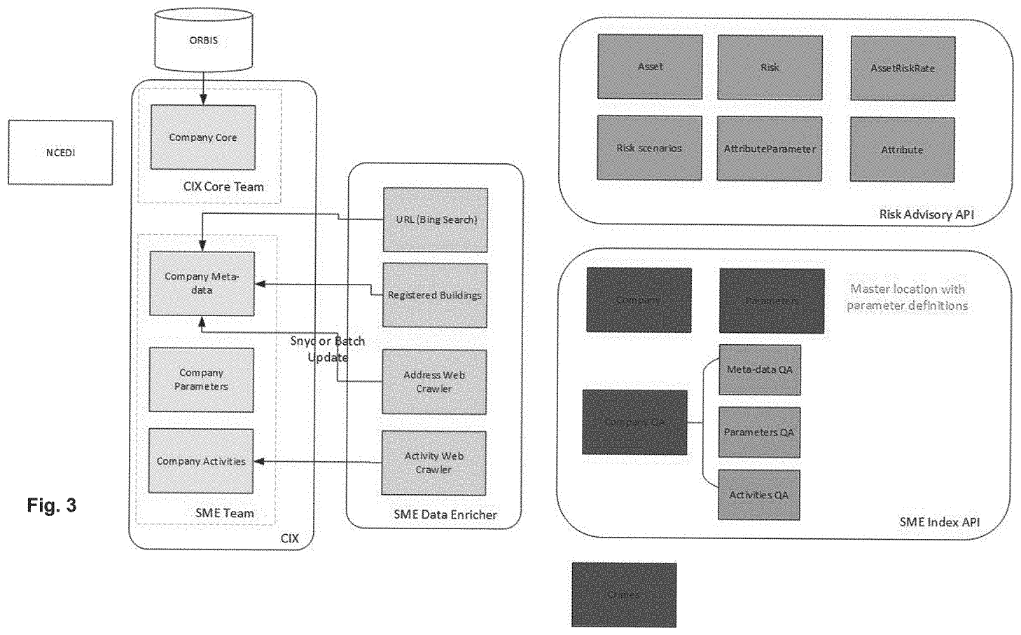

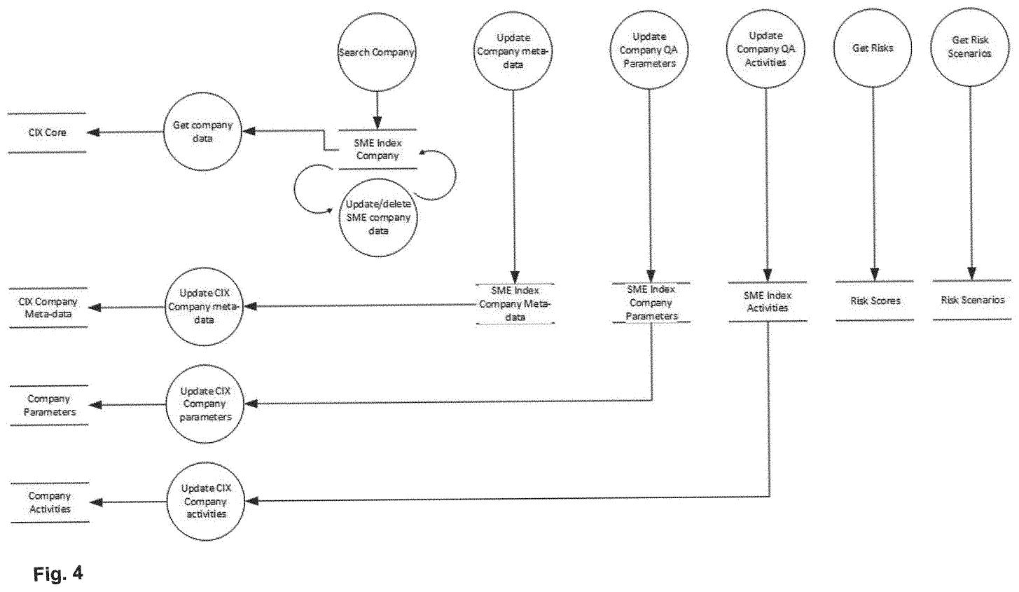

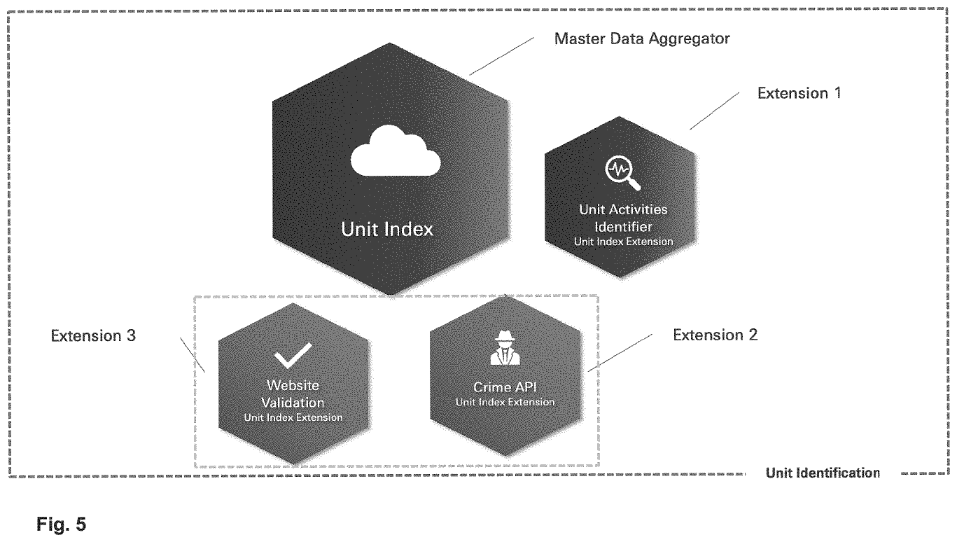

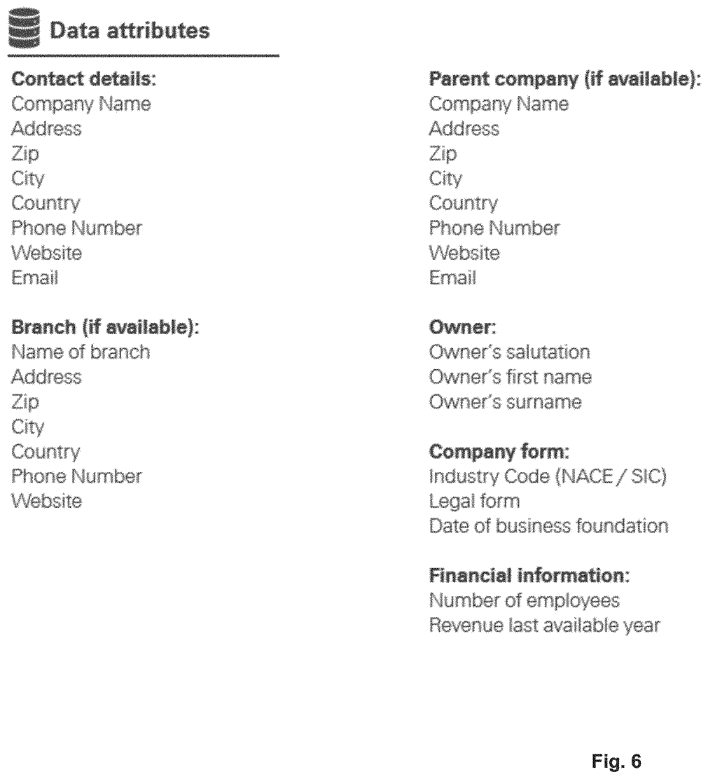

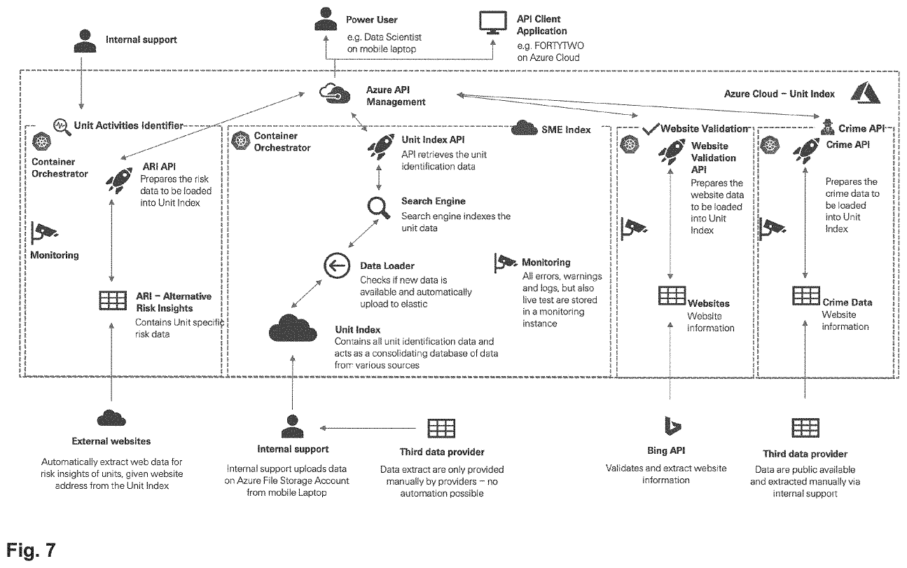

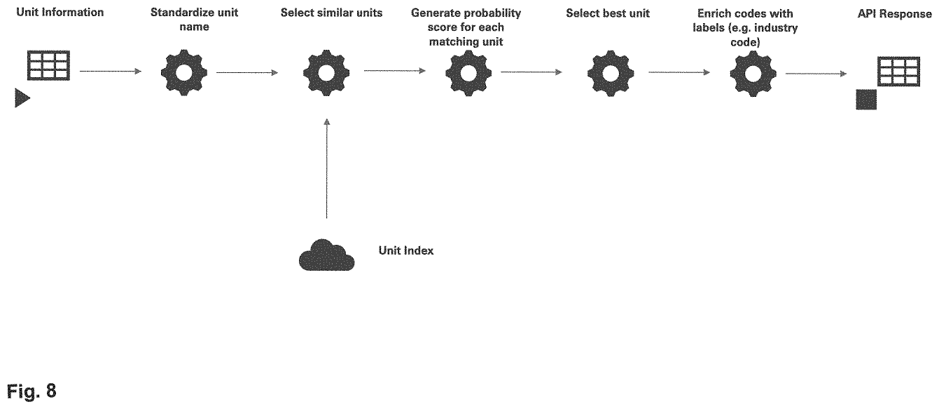

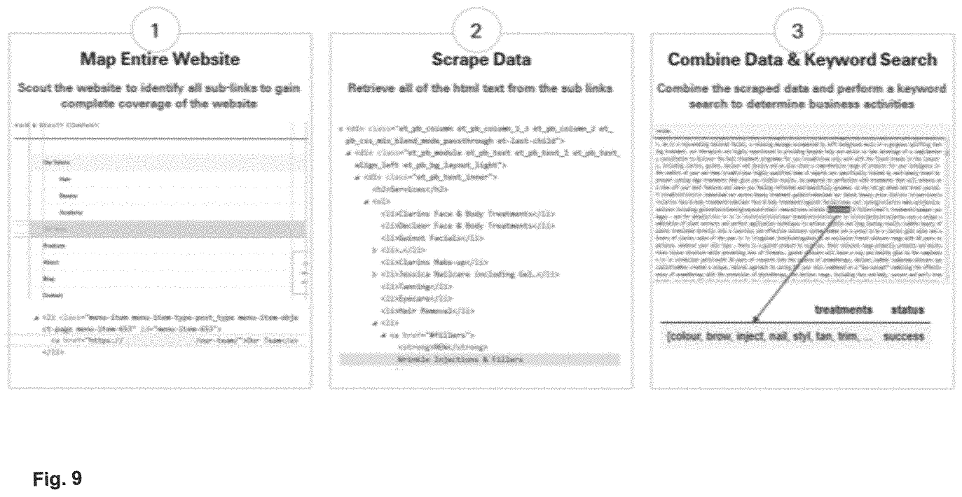

For capturing the asset characteristics parameters 1121 of a unit 21,22, . . . ,2i the digital platform 1 can e.g. match the business name of a risk-exposed unit 21,22, . . . ,2i to various internal and external data sources, in particular also to data stored in an index-data structure 1101, also denoted herein as SME index or SME index data structure. As illustrated in FIG. 2, there is an inventive relation structure between the SME index, the risk events, the risk scoring and the risk scenarios, wherein the SME Index measure providing at least location parameter values, attributes' values of the assets 2i1 and/or the risk-exposed units 2, 21,22, . . . ,2i and activities' parameter values of the assets 2i1 and/or the risk-exposed units 2, 21,22, . . . ,2i. The measured risk events are covered by a defined set of inherent and exogenous risks, i.e. a set of measurable probabilities for the occurrence of a risk event within a defined range of physical measuring parameters and a future measuring time period. The SME Index measure determines which risk events or hazards are relevant and how they are influenced, i.e. how frequent and severe they are. The scoring is the technical structure automatically recognizing and assigning relevant risks to the assets 2i1. Each measured attribute value increases/decreases the risk measure to different extent. For example, the measured flood risk for asset equipment 2i1 combined with risk measures for all other assets 2 providing total score for the measured flood risk measure. The triggered list of risks for the risk-exposed unit 2, 21,22, . . . ,2i ranks from greatest to smallest measured risks for this particular risk-exposed unit 2, 21,22, . . . ,2i. The implemented scenarios provides a risk structuring. The selected scenario for each risk show the most relevant risk driver for that particular risk-exposed unit 2, 21,22, . . . ,2i. Further, scenarios reflect location, attributes, activities and hazards and are customized to it, e.g. measured cyber risk=high (high because: website host, online registration, security measures). The greatest vulnerability measure (booking system) is equal to the scenario basis.

For the process of the identification of the asset characteristics parameters 1121 of a unit 21,22, . . . ,2i, the digital platform 1 can e.g. comprise an automated parameter-indexing module 110 automatically detecting, assessing and triggering asset characteristics parameters 1121 of a selected unit 21,22, . . . ,2i by means of an index-data structure 1101. The parameter-indexing module 110 can e.g. comprises a data aggregator 1102 triggering for or measuring and assessing parameter attributes for providing the asset characteristics parameters 1121, at least comprising assets 11012 and asset classes 11311, . . . ,1131i of the selected unit 21,22, . . . ,2i, location of the assets 11014, and activities 11015 of the selected unit 21,22, . . . ,2i associated with an asset and/or asset class 11311, . . . ,1131i, and/or other risk-related parameter data. In case of lacking or incomplete assessing of asset characteristics parameters 1121, parameters of the index-data structure 1101 can be automatically populated and enriched by means of a machine-based intelligence 1103. The index-data structure 1101 can e.g. be populated and enriched by the machine-based intelligence 1103 based at least on closest proximity processing steps. By means of the automated parameter-indexing module 110 the occurring risk events and/or variations in the asset characteristics parameters 1121 can be dynamically monitored by detecting and/or measuring and/or triggering of associated parameter values. The monitoring can e.g. be realized using Application Insights of Azure Monitor as extensible Application Performance Management (ARM). The automated parameter-indexing module 110 comprises a search engine for leveraging the asset characteristics parameters 1121 of a selected unit 21,22, . . . ,2i held by the indexer-data structure, wherein the asset characteristics parameters 1121 are contained within the search engine instances using a cluster configuration. The search engine can e.g. be realized as an ElasticSearch engine leveraging a cluster of ElasticSearch containers, wherein the asset characteristics parameters 1121 are contained within the search engine instances using a cluster configuration of the ElasticSearch engine, and wherein detected data are saved in a NoSQL-format as JavaScript Object Notation (JSON). The automated parameter-indexing module 110 comprises unit activities identifier application programming interface (API) collecting asset characteristics parameters 1121 by accessing accessible websites of each selected unit 21,22, . . . ,2i and identifying if there is any relevant information assessible, wherein websites' texts are scanned and triggered for certain keywords indicating whether a certain activity or type of activity is undertaken by the selected unit 21,22, . . . ,2i. For collecting asset characteristics parameters 1121, the unit activities identifier application programming interface (API) can e.g. process the steps of (i) mapping a content of an accessed website by scouting the website to identify all sub-links, (ii) scraping content data of all the site content of all sublinks, and (iii) combining data and performing a keyword-based search of the scraped content data to trigger and detect unit activities.

The risk score 1124 can e.g. be generated by the risk advisory module 11 and assigned to each profile section 1123 of the risk profile 112, wherein the risk score 1124 is based on the parameter values of the index-data structure 1101 generated by the automated parameter-indexing module 110, the risk being parametrized using geographic location 11014, attributes 11016 and activities 11015 as three parameter dimensions, and wherein, based on the geographic location 11014, the risk is determined by risk classes associated with the geographic location 11014. The attributes 11016 can e.g. comprise parameter values determining physical characteristics of the selected unit 21,22, . . . ,2i or asset of the unit 21,22, . . . ,2i and/or characteristics of employees of the selected unit 21,22, . . . ,2i and/or unit-specific procedures. The assets of the selected unit 21,22, . . . ,2i is scored as well as the associated risk measures. Thus, in summary, for the risk scoring, data are collected and made usable in the index-data structure 1101. The risk scoring is interpreting this data and transforms it into information that a user can understand intuitively the scoring. This has the advantage that the end-user does not see the input data but only the easy to understand output. As an embodiment variant, the risk can be represented visually by colors and bars. To get to this representation, the unit/business can be captured along said three dimensions: (i) Location; (ii) Attributes, (iii) Activities. The location is the geographical location. The geographical location determines the risk in several risk classes: (i) Natural perils, (ii) Jurisdiction (e.g. applicable building codes, liability), (iii) Intervention (e.g. how quickly can an ambulance be there?), (iv) Man-made perils (e.g. proximity to a sight determining terror risk, crime). The location is an exogenous factor that the business has no control over (e.g. jurisdictional boundary condition parameters). The risk-exposed unit 21,22, . . . ,2i, i.e. the SME unit, however, is not usually able to interpret such exogenous factors and what are their impact to the measures of their operation or business. The score provides a reproducible physical measure for such an interpretation, translating exogenous factors such as jurisdictional boundary condition parameters into the mentioned score, providing said measure for the impact on risk, the probability for the occurrence of a risk event gibing raise to the impact. A risk-exposed unit (21,22, . . . ,2i) usually does not have the skills to know and trigger those exogenous factors nor have the skills to physically quantify them as appropriate physical measures. The quantification (score) closes that gap, using internal data sources such as hazard maps or insights into how the legal framework increases or decreases risk. The attributes describe the physical characteristics of the risk-exposed unit (21,22, . . . ,2i) and the business, respectively, and the characteristics of its employees as well as procedures it follows, e.g.: (i) Construction type of the building, (ii) Fire alarm linked to fire brigade, (iii) Only employs staff with recognized qualification, (iv) Regular awareness trainings for employees. Attributes are endogenous, i.e. specific to a risk-exposed unit (21,22, . . . ,2i) and business, respectively, and mostly under the control of the business. While a business at the same location will always be exposed to the same exogenous factors, the endogenous factors might change. Still, a risk-exposed unit (21,22, . . . ,2i) is usually not able to quantify what it means if it e.g. regularly trains its employees in safety measures. The score quantifies these endogenous factors for the risk-exposed unit (21,22, . . . ,2i). Activities describe what the unit/business does, allowing for a much more granular assessment than usual in risk-transfer systems, where units/businesses are classified in broader categories. For each of the broader categories normally used, the inventive platform 1 defines a list of activities. Each activity has a different inherent risk, e.g.: Units/businesses not working with sharp objects (contrary to e.g. restaurants) have a lower risk normally associated with the use of sharp objects such as knives. An inherent risk cannot be changed, it can only be mitigated. Mitigation comes from the exogenous and endogenous factors and are applied to the inherent risk. This process of matching the relevant exogenous and endogenous factors to the inherent risk, is a process that requires advanced risk knowledge usually not present in SME, i.e. the risk-exposed units (21,22, . . . ,2i).

The digital platform provides a connection between the digital system 1′ and user interfaces, wherein data can be displayed to a user and unit 2/3, for example, in an overview page provided to the unit 2/3 via the interface 16. The risk profile 112 comprises a plurality of profile section 1123 comprising asset section 11231 being associated with an asset class 11311, . . . ,1131i and risk sections 11232 being associated with a risk type 1141. Each predefined asset class 11311, . . . ,1131i is linked with one or more risk types 1141 and each predefined risk type 1141 is linked with one or more asset classes 1141. An asset class 11211, . . . ,1121i comprises all the relevant risk categories 1141 associated with that class. Each type of risk 1141 can e.g. be displayed to the unit 21,22, . . . ,2i with a brief definition highlighting common issues associated with the type of risk 1141.

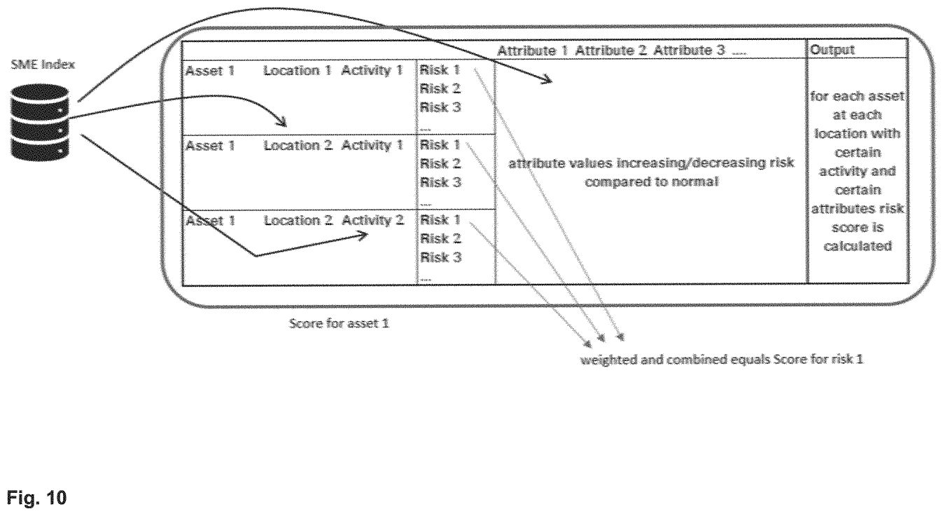

Triggered and driven by the measured and captured parameter vales, the platform 1 is enabled to score the assets of a unit/business as well as the risks. Assets are defined by unit, some of which will be repetitive (e.g. most risk-exposed units (21,22, . . . ,2i) will be located in a building, have customers, employees) and some unique (specialized activities, specialized skills or machinery). Assets are everything needed to run a unit/business. Risks are events that can affect the assets, e.g. a flood (risk) can destroy the building (asset). FIG. 10 describes such a basic scoring process. It provides scores for all assets and all risks. The resulting numerical value is translated into intuitive visual information. The calculation uses all information from all three areas (location, attributes, activities). The location may indicate a high risk (e.g. high crime area) but attributes may mitigate it (e.g. sophisticated alarm system) and the activity (e.g. hairdresser) indicates a lower propensity to crime as opposed to e.g. a jeweler but the building contains an ATM, thus increasing the risk again. All those and more factors are weighted according to their contribution to the overall risk to the risk category (here: crime). The process is repeated for all risks and all assets, resulting in a score for each risk and asset. The assets and risks are ranked by importance to the specific business. The risk most likely to impact the business both in terms of frequency and severity will be ranked highest, thus immediately showing the greatest risk to most likely harm the business. The business gains insights into which risks are a big threat to its operations and which ones have a lower impact.

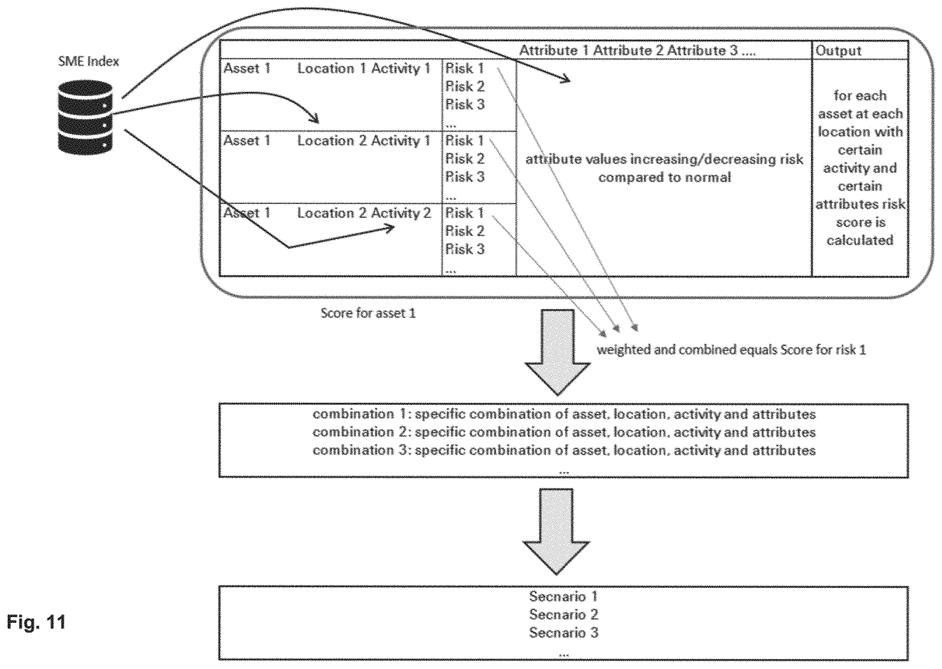

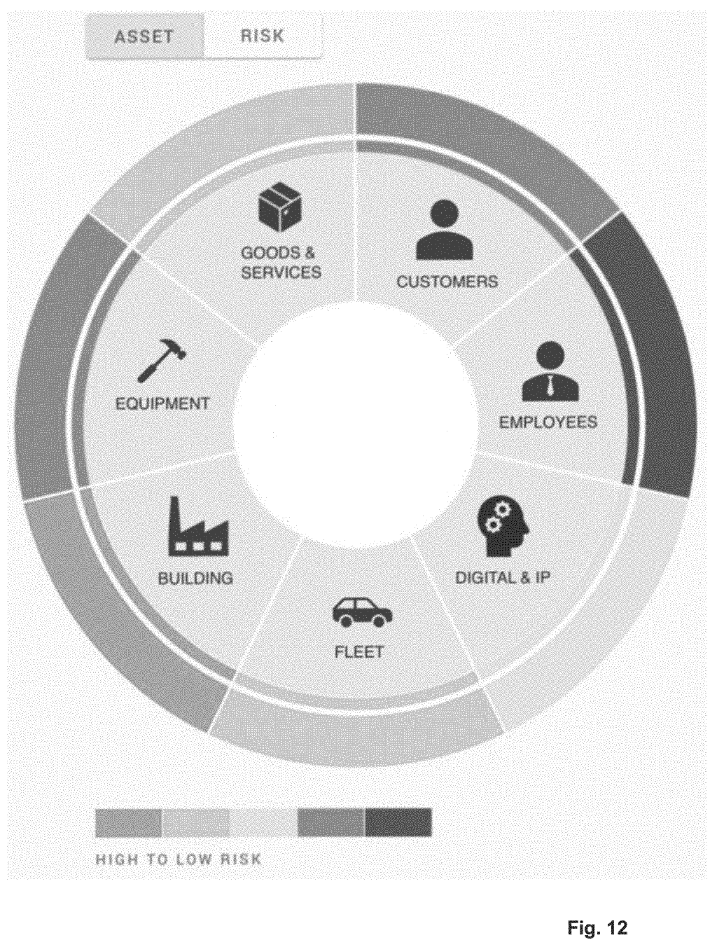

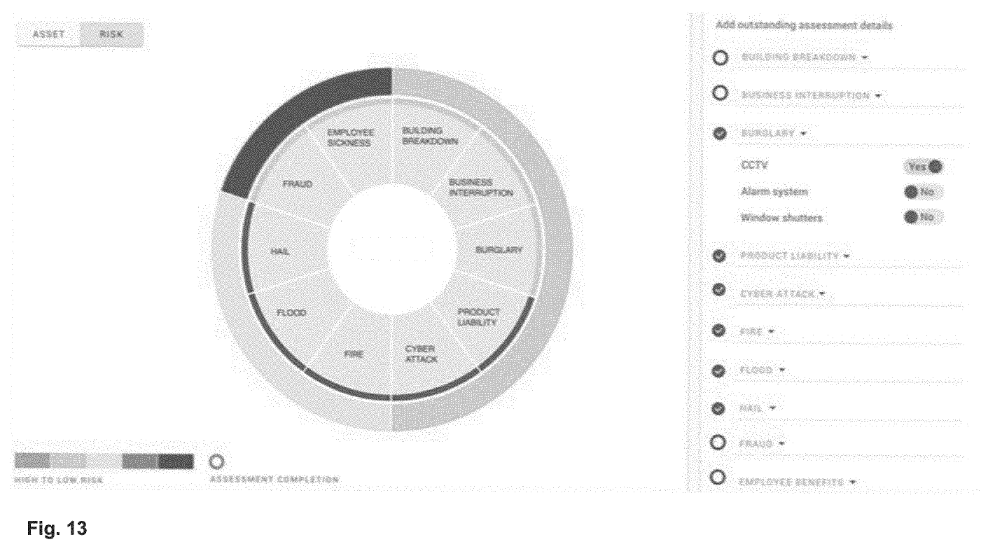

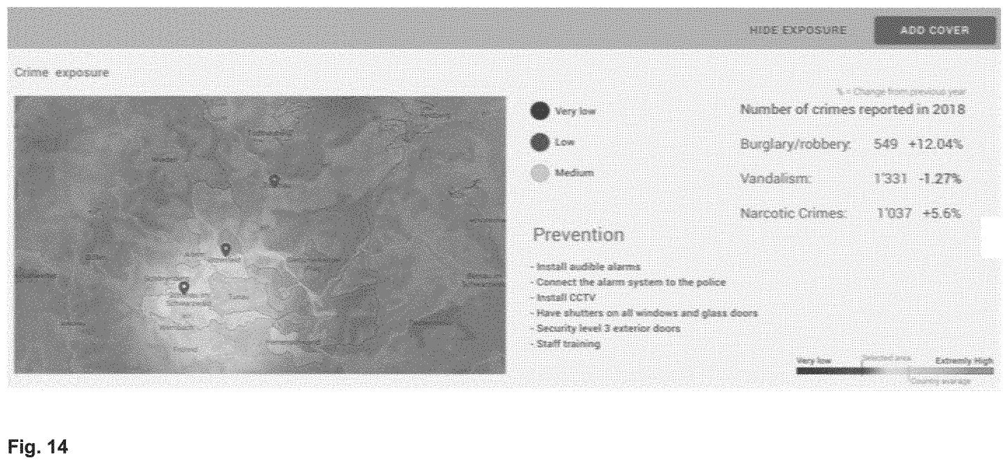

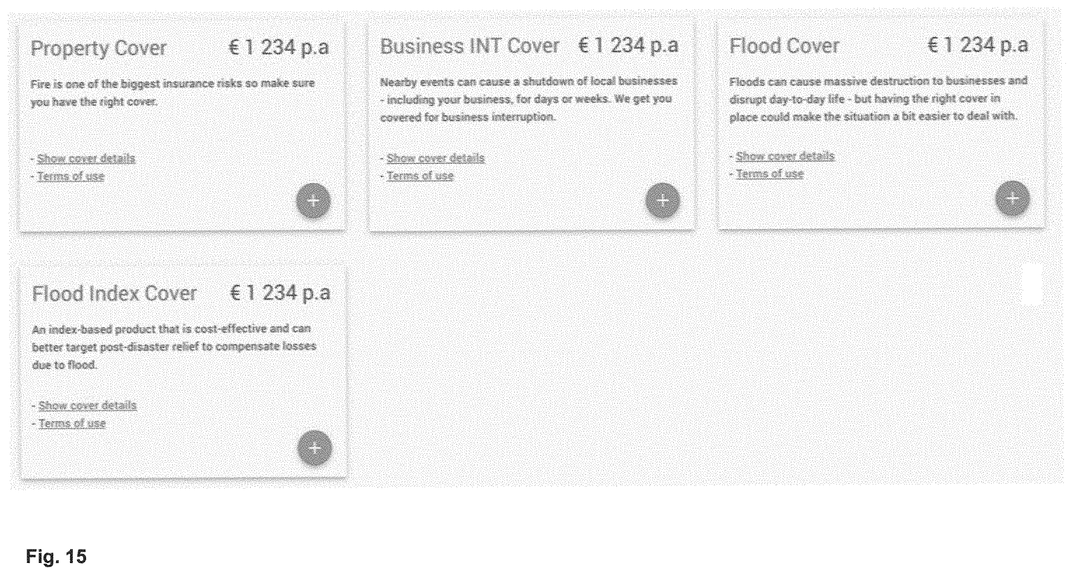

The digital platform can e.g. comprise a scenario-based risk processor 116 linking for each possible combination of location, activities and attributes at least one of predefined scenarios 1162 held in a scenario database 1161, wherein a scenario-based score is assigned to each possible combination. Based on the score, an expert advice can e.g. be generated covering a description of the scenario and/or its relevance and/or possible prevention mechanism performable by the unit 21,22, . . . ,2i. Scenarios are one of the centerpiece of the risk advisory module 11. The risk scoring provides measures and insights into riskiness. The risk advisory module 11 interprets the results for the end-user for each asset and risk. As an expert system, it is enabled to provide answers to the following questions: (i) What is it?; (ii) What can happen?, (iii) What can you do about it?. For each possible combination of location, activities and attributes there are scenarios available. Depending on the score, the relevant scenario can e.g. be displayed (see FIG. 11). The scenarios use examples explaining why a particular risk is at the top. The business will thus immediately understand why a certain risk is more important than another. The business will also learn how to mitigate such risks and make their business operations safer.

The digital platform 1 comprises an automated underwriting and pricing module 13, wherein base rates 13412 for applicable risk-transfer covers 13411 are provided and corresponding pricings 13414 are generated based on the base rates 13412, associated rate factors 13413 and value parameters of the asset characteristics parameters 1121. Different applicable risk-transfer covers 13411 are generated based on the correspondingly relationship 10i1 between a risk source 10i11, a risk exposure measure 10i12 and a risk exposed asset 10i13 and are assigned to a profile section 1123 of the risk-exposed unit 21,22, . . . ,2i. For example, the digital platform the system 1 can comprise a prediction engine 115 for automated prediction of forward-looking impact measures 1151 based on event parameter values 11421 of time-dependent series of occurrences of physical impacting risk-events 1142. In this case, the occurrences of the physical risk-events 1142 can be measured based on predefined threshold-values of the event parameters 11421 and the impacts of the physical risk-events 1142 to a specific asset 211 can be measured based on impact parameters 11421 associated with the asset 2i1. For capturing the risk event parameters 11421, the prediction engine 115 can e.g. comprise a machine-based exposure data intelligence 1153 enabled to automatically identify risks of assets 2i1 based on at least a location of the asset 2i1.

A risk score 1124 is generated by the risk advisory module 11 and assigned to each profile section 1123 of the risk profile 112. The interactive portfolio steering is provided by inter-actively assigning and adjusting risk-transfer covers to the risk-transfer portfolio 101, 102, . . . ,10i by a unit 21,22, . . . ,2i associated with said portfolio 101, 102, . . . ,10i. The interactive portfolio steering can e.g. also be provided by inter-actively assigning and adjusting risk-transfer covers to the risk-transfer portfolio 101, 102, . . . ,10i by a broker unit 31,32, . . . ,3i, instead of the risk-exposed unit 21,22, . . . ,2i, representing a risk-exposed unit 21,22, . . . ,2i associated with said portfolio 101, 102, . . . ,10i.

The digital platform 1 further can e.g. comprise an automated complementary advisory module 14 providing customized advisory visualization 141 of the risk profile 112 to the unit 21,22, . . . ,2i associated with the risk profile 112 by actionable, tangible and data-driven risk-transfer insights. The digital platform 1 can further comprise a graphical user interface provided by the risk advisory module 11 for generating a dynamic representation of a portfolio structure 101, 102, . . . ,10i. By means of the prediction engine 115, the dynamic representation of the portfolio structure 101, 102, . . . ,10i can e.g. provide forward-looking insights to a user or unit 2/3 thereby enabling portfolio steering by identification of critical areas and/or sections of a portfolio 101, 102, . . . ,10i and a risk profile 112 and impacts of possible changes to the risk-exposure of the corresponding profile sections 11231/11232. The machine-based exposure data intelligence 1153 can e.g. assesses the exposure database 114 which comprises a plurality of data records 11421 holding attribute parameter of assets 2i1 at least with assigned geographic location parameters. The machine-based exposure data intelligence 1153 can further comprise a clustering module for clustering stored assets 2i1 of the exposure database 114 related to their assigned geographic location parameters, and wherein different data records of the exposure database 114 having the same or close geographic location parameters are matched and the risk-exposures of a specific asset 2i1 of a unit 2i are aligned with the risk-exposures of the data records 11421 having the same or close geographic location parameters.

As an embodiment variant, the digital platform 1 can e.g. comprise a portfolio manager module 12 providing the segmentation 1261, classification 1262, risk exposure measurement and/or risk scoring 1263, and interactive exposure steering 1264 of large risk pools. A risk pool can comprise a plurality of asset classes 11311, . . . ,1131i of a risk-exposed unit 21,22, . . . ,2i, wherein the asset classes 11311, . . . ,1131i are associated with at least risk exposure induced by buildings and/or equipment and/or goods/services and/or customers and/or employees and/or digital/IP-assets and/or fleet. As a further variant, the digital platform 1 can also comprise a portfolio manager module 12 providing the segmentation 1261, classification 1262, risk exposure measurement and/or risk scoring 1263, and interactive exposure steering 1264 of large risk pools. The risk pool can comprise a plurality of risk types 1141 of a risk-exposed unit 21,22, . . . ,2i, wherein the risk types 1141 are associated with at least comprise fire events and/or flood events and/or hail events and/or fraud events and/or employee sickness events and/or building breakdown events and/or business interruption events and/or burglary events and/or product liability events and/or cyber-attack events.

The use and access of the digital platform 1 can be made more user-friendly by implementing the unit interfaces 1211 accessible over the interface 16 as a Web Application, which enables the user to assess the digital platform e.g. via the worldwide backbone network Internet. The WebApp can be realized by using an API with appropriate http request and response processes.

### LIST OF REFERENCE SIGNS

1 Automated digital platform comprising digital system 1′
10 Persistence storage holding portfolio data
   101, 102, . . . ,10i Risk-transfer portfolio data assigned to unit 2i
      10i 1 Relationships
         10i11 Risk source
         10i12 Risk exposure measure
         10i121 Occurrence probability of risk event
         10i122 Occurrence strength
         10i13 Risk exposed asset
      10i2 Submission of risk-exposed unit 2i for portfolio 10i
      10i3 Risk-exposed 10i unit assigned to portfolio data
      10i4 Applied risk-transfers
11 Risk advisory module
   110 Automated parameter-indexing module
      1101 Index-data structure
         11011 Unit
         11012 Assets
         11013 Asset classes
         11014 Asset location
         11015 Activities associated with an asset
         11016 Attributes
      1102 Data aggregator
      1103 Machine-based intelligence
   111 Risk profile database
   112 Risk profiles of database 111
      1121 Asset characteristics parameters of unit 2i′s asset
      1122 Asset classes of unit 2i′s assets
      1123 Profile sections
         11231 Asset sections
         11232 Exposure sections
      1124 Risk scores of each of the profile sections
      1125 Risk-exposure of a specific asset of unit 2i
   113 Asset classifier
      1131 Asset class database
         11311, . . . , 1131i Asset classes
      1132 Matching structure
   114 Exposure database
      1141 Risk types/class
      1142 Risk sources/Risk event
         11421 Historical risk event parameters
         11422 Predicted risk event parameters
   115 Prediction engine (Risk scoring)
      1150 Occurrence probabilities of risk events
      1151 Impact measures
      1152 Risk-exposure measures
      1153 Machine-based exposure data intelligence
   116 Scenario-based risk processor
12 Portfolio manager module
   121 Access controller
      1211 Risk-exposed/broker unit access interface
      1212 Submission database
         12121 Submission data of unit 21
         12122 Submission data of unit 22
         . . .
      1212i Submission data of unit 23
      1213 Submission analyzer
   122 Portfolio analyzer
   123 Collaboration module
   124 Document management module
   125 Visualization module
   126 Portfolio manager processes
      1261 Segmentation
      1262 Classification
      1263 Risk exposure measurement/risk scoring
      1264 Interactive exposure steering
13 Underwriting and pricing module
   131 Communication database
   132 Profile database holding risk-exposed unit accounts
      1321 Risk-exposed unit profiles
   133 Profile database holding broker unit accounts
      1331 Broker unit profiles
   134 Quote module
      1341 Quote engine
         13411 Applicable risk transfers
         13412 Base rates
         13413 Rate factors
   135 Billing/Accounting module
14 Complementary advisory module
141 Customized advisory visualization
15 Web server
   151 Firewall
   152 Router
16 Network Interface

2 Risk-exposed units (entities)
21, 22, . . . ,2i Risk-exposed unit
   2i1 Assets of the risk-exposed unit 2i
      2i11, . . . ,2i1x Measuring devices/sensors associated with the
         asset 2i1
   2i2 Network-enabled device of risk-exposed unit 2i
      2i21 Network interface

3 Broker units
31, 32, . . . ,3i Broker unit
   3i1 Skill certifications of deployment unit 3i
   3i2 Network-enabled device of deployment unit 3i
      3i21 Network interface

4 Data Transmission Network
41 Worldwide backbone network Internet

5 Secure cloud-based network
51, 52, . . . ,5i Dedicated secure network
   5i1 Controlled cloud-based network access to secure network 5i

1. A digital device comprising:
a plurality of sensors;
a storage configured to store transfer portfolio data including at least a relationship between a risk source, a risk exposure measure, and a risk exposed object;
circuitry configured to:
measure, by the plurality of sensors, characteristics parameters of a plurality of objects,
assign the measured characteristics parameters to a profile associated with the plurality of objects,
classify the plurality of objects into a plurality of classes based on the measured characteristics parameters, each class being associated with a plurality of risk types, wherein the profile includes a plurality of sections, each section associated with the corresponding class,
generate a transfer cover value based on (i) the measured characteristics parameters and (ii) the relationship between the risk source, the risk exposure measure, and the risk exposed object of the transfer portfolio data stored in the storage,
assign the generated transfer cover value to the corresponding section of the profile for the risk exposed object, and
generate a risk score value to the corresponding section of the profile based on the assigned transfer cover value.

2. The digital device according to claim 1, wherein the circuitry is further configured to automatically detect, assess, and trigger characteristics parameters of a selected object with an index data structure, wherein the characteristics parameters include at least locations and activities of the selected object.

3. The digital device according to claim 2, wherein the circuitry is further configured to automatically populate incomplete characteristics parameters by a machine-based intelligence.

4. The digital device according to claim 3, wherein the circuitry is further configured to populate the incomplete characteristics parameters by the machine-based intelligence based at least on closest proximity processing steps.

5. The digital device according to claim 2, wherein the circuitry is further configured to dynamically monitor variations in the characteristics parameters.

6. The digital device according to claim 5, wherein the monitoring is realized using Application Insights of Azure Monitor as extensible Application Performance Management (ARM).

7. The digital device according to claim 2, wherein the circuitry includes a search engine for leveraging the characteristics parameters of a selected object held by indexer-data structure, the characteristics parameters being contained within the search engine using a cluster configuration.

8. The digital device according to claim 7, wherein the search engine is realized as an ElasticSearch engine leveraging a cluster of ElasticSearch containers, wherein the characteristics parameters are contained within the search engine using a cluster configuration of the ElasticSearch engine, and wherein detected data are saved in a NoSQL-format as JavaScript Object Notation (JSON).

9. The digital device according to claim 2, wherein the circuitry includes unit activities identifier application programming interface (API) collecting characteristics parameters by accessing assessable websites of each selected object and identifying any relevant information assessible, wherein websites' texts are scanned and triggered for certain keywords indicating whether a certain activity or type of activity is undertaken by the selected object.

10. The digital device according to claim 9, wherein, for collecting the characteristics parameters, API processes steps of (i) mapping a content of an accessed website by scouting the website to identify all sub-links, (ii) scraping content data of all site content of the all sub-links, and (iii) combining data and performing a keyword-based search of the scraped content data to trigger and detect activities.

11. The digital device according to claim 2, wherein the risk value is based on parameter values of the index-data structure, a risk being parametrized using a geographic location, attributes, and activities as three parameter dimensions, and wherein, based on the geographic location, the risk is determined by risk classes associated with the geographic location.

12. The digital device according to claim 11, wherein the attributes comprise parameter values determining physical characteristics of the selected object, characteristics of employees of the selected object, or unit-specific procedures.

13. The digital device according to claim 1, wherein assets of the selected object is scored as well as risk measures associated with a selected object.

14. The digital device according to claim 1, wherein the circuitry is further configured to link each possible combination of locations, activities, and attributes and assign a scenario-based score to each possible combination.

15. The digital device according to claim 14, wherein based on the scenario-based score an expert advice is generated covering a description of the scenario.

16. The digital device according to claim 1, wherein the circuitry is further configured to provide a customized advisory visualization of the profile to an object associated with the profile.

17. The digital device according to claim 1, wherein the circuitry is further configured to provide automated prediction of forward-looking impact measures based on event parameter values of time-dependent series of occurrences of physical events, wherein the occurrences of the physical events are measured based on predefined threshold-values of event parameters and impacts of the physical events to a specific object are measured based on impact parameters associated with an object.

18. The digital device according to claim 17, wherein for capturing the event parameters, the circuitry includes a machine-based exposure data intelligence enabled to automatically identify risks of objects based on at least a location of the object.

19. The digital device according to claim 17, the circuitry includes a graphical user interface for generating a dynamic representation of a portfolio structure, wherein the dynamic representation of the portfolio structure provides forward-looking insights to a user thereby enabling portfolio steering by identification of critical sections of the portfolio and the profile and impacts of possible changes to a risk-exposure of the corresponding sections of the profile.

20. The digital device according to claim 18, the machine-based exposure data intelligence assesses exposure database including a plurality of data records holding attribute parameter of objects at least with assigned geographic location parameters, wherein the machine-based exposure data intelligence includes a clustering module for clustering stored objects related to assigned geographic location parameters, and wherein different data records of the stored objects having the same geographic location parameters are matched and risk-exposures of a specific object are aligned with risk-exposures of the data records having the same geographic location parameters.

21. The digital device according to claim 1, wherein the circuitry is further configured to interactively assign and adjust transfer cover values to the risk exposed object of the transfer portfolio data.

22. The digital device according to claim 1,
wherein the classes are associated with at least risk exposure induced by buildings, equipment, goods, services, customers, employees, digital/IP-asserts, or fleet.

23. The digital device according to claim 1,
wherein the risk types are associated with at least one of fire events, flood events, hail events, fraud events, employee sickness events, building breakdown events, business interruption events, burglary events, product liability events, and cyber-attack events.

24. A method for automated risk-transfer, the method comprising:
storing transfer portfolio data including at least a relationship between a risk source, a risk exposure measure, and a risk exposed object;
measuring, by a plurality of sensors, characteristics parameters of a plurality of objects;
assigning the measured characteristics parameters to a profile associated with the plurality of objects;
classifying the plurality of objects into a plurality of classes based on the measured characteristics parameters, each class being associated with a plurality of risk types, wherein the profile includes a plurality of sections, each section associated with the corresponding class;
generating a transfer cover value based on (i) the measured characteristics parameters and (ii) the relationship between the risk source, the risk exposure measure, and the risk exposed object of the transfer portfolio data stored;
assigning the generated transfer cover value to the corresponding section of the profile for the risk exposed object; and
generating a risk score value to the corresponding section of the profile based on the assigned transfer cover value.
